(19) United States
(12) Patent Application Publication
(10) Pub. No.: US 2026/0037425 A1
(43) Pub. Date: Feb. 5, 2026

(54) GENERATING A LOGICAL TO PHYSICAL DATA STRUCTURE STORED BY A HOST DEVICE

(71) Applicant: Microchip Technology Incorporated, Chandler, AZ (US)

(72) Inventors: Nian Niles YANG, Mountain View, CA (US); Pitamber SHUKLA, San Jose, CA (US); Bob DIVIVIER, San Jose, CA (US)

(21) Appl. No.: 19/002,635

(22) Filed: Dec. 26, 2024

Related U.S. Application Data
(60) Provisional application No. 63/678,058, filed on Aug. 1, 2024.

(51) Int. Cl. G06F 12/02

(52) U.S. Cl. CPC G06F 12/0246; G06F 12/0253

(57) ABSTRACT

A host device may determine a storage structure of a storage medium of a solid state drive (SSD). The host device may determine a physical block address to be used by a logical block address based on determining the storage structure. The host device may generate a logical 2 physical (L2P) entry that maps the physical block address to the logical block address. The host device may store the L2P entry in an L2P data structure that is stored in a first memory of a host device, wherein a copy of the L2P data structure in a second memory of a controller of the SSD. The host device may provide, to the controller, the physical block address and the logical block address. The addresses may be provided to perform a write operation or a read operation at a physical location, of the storage medium, identified by the physical block address.

### RELATED APPLICATION

This application claims priority to U.S. Provisional Patent Application No. 63/678,058 entitled “GENERATING A LOGICAL TO PHYSICAL DATA STRUCTURE STORED BY A HOST DEVICE,” filed Aug. 1, 2024, which is incorporated herein by reference in its entirety.

### FIELD

The present disclosure generally relates to logical to physical (L2P) address mapping for non-volatile memory devices and, for example, to reducing a size of an L2P data structure of a non-volatile memory device.

### BACKGROUND

A non-volatile memory device may include a memory device that may store and retain data without external power supply. One example of a non-volatile memory device is a NAND flash memory device, without limitation. A solid-state drive (SSD) may include a plurality of non-volatile memory devices, such as NAND flash memory devices, without limitation. The non-volatile memory devices may store data that is accessible via a controller of the SSD. The controller of the SSD may maintain a table that maps logical block addresses (associated with the host computing device) to physical block addresses (of the SSD). The table may be referred to as a logical to physical (L2P) table.

### BRIEF DESCRIPTION OF THE DRAWINGS

FIG. 1 is a diagram of an example storage structure discovery procedure in accordance with some examples described herein.

FIG. 2 is a diagram of an example data structure that represents an L2P table in accordance with some examples described herein.

FIG. 3 is a diagram of an example implementation of storing an L2P table by a host device, in accordance with some examples described herein.

FIG. 4 is a diagram of an example of operational and/or health monitoring of one or more storage media, in accordance with some examples described herein.

FIGS. 5 and 6 are diagrams of example read and write operations performed by a host device, in accordance with some examples described herein.

FIG. 7 is a flow chart of an example as described herein.

FIG. 8 is a diagram of an example of a system described herein.

FIG. 9 is a flowchart of an example process associated with generating an L2P data structure stored by a host device.

### DETAILED DESCRIPTION OF PREFERRED EMBODIMENTS

The following detailed description of example implementations refers to the accompanying drawings. The same reference numbers in different drawings may identify the same or similar elements.

Typically, a controller of an SSD may use a logical to physical (L2P) data structure to perform a mapping between logical block addresses (e.g., logical addresses identified by a host device) and physical block addresses (e.g., physical addresses of non-volatile memory devices). The L2P data structure may be stored on a memory of the controller (e.g., stored on a random-access memory (RAM)). The controller may include one or more of an application specific integrated circuit (ASIC) or firmware.

With the advent of artificial intelligence (AI) applications, data center solutions, and other applications, the demand for the amount of data to be stored by SSDs is rapidly increasing. As storage size of an SSD increases, the likelihood of the controller of the SSD becoming a bottleneck increases due to, for example, the speed mismatch between host central processing unit (CPU) and/or graphics processing unit (GPU) bandwidth and the capabilities of the controller of the SSD.

Traditionally, a host device does not have control regarding a manner in which the SSD will process the data. For example, the host device does not have access or insight as to the storage structure of the SSD, including which storage media (or addresses thereof) of an SSD are used for writing particular data. As used herein, a “storage structure” may be used to refer to an arrangement of physical memory addresses of the SSD, such as a quantity of storage mediums, identifiers of storage mediums, physical addresses associated with a storage medium, or other suitable information which may be used to identify or access physical addressable memory locations of storage mediums of the SSD. In this regard, a technical problem may be directed to a manner in which the host system may gain a better insight and, thus, control the SSD addressing for more coherent data processing in hyperscale applications.

Typically, a memory, such as a synchronous dynamic random access memory (SDRAM) of an SSD is used to store all of the logical block addresses (LBAs) of data stored in the SSD, as well as their mapping to physical block addresses (PBAs) of the SSD. The mapping may, for example, be stored in a conversion table (e.g., an L2P table). As a result of a write command from a host, the controller of the SSD will typically create an L2P entry in the L2P table, with an LBA-PBA mapping corresponding to the data that is the subject of the write command. As a result of a host read command, the controller will typically search L2P entries to identify a PBA that corresponds to an LBA that is the subject of the read command, in order to provide the requested data to the host device.

A technical problem, associated with this addressing scheme in which the SSD controller performs L2P mapping operations, is that the host device is unaware of a physical location of the data, such as a particular storage medium of the SSD on which the data is recorded or a physical portion (e.g., address) within such storage medium. Accordingly, accessing the data is dependent on an internal operation latency of the SSD. In other words, a speed or amount of delay at which the host accesses the data is subject to the internal operational latency of the controller of the SSD. As such, L2P operations being performed by the controller may ultimately be a bottleneck for writing or reading data to or from the SSD.

Additionally, the host may not have access to (e.g., may be unaware of) internal, “background” operations performed by the controller, such as garbage collection, health monitoring, trimming, read scrub, bad block management, or the like. Input/output (I/O) commands, such as read and/or write commands, may thus be subject to seemingly random latency that may result from the controller performing such operations while an I/O command is received from the host.

Using the SSD for the AI data processing has become a new focus for next-generation SSD development. However, no known consensus currently exists for the best practice for accessing the data without being subject to the internal operation latency of the SSD.

Implementations described herein provide a technical solution to the technical problem discussed above with respect to a host device being subject to latency of the SSD when the host device is performing I/O operations with respect to an SSD, such as accessing data stored on an SSD or writing data to the SSD. For example, in some implementations described herein, a host device may manage SSD data addressing (e.g., L2P mapping operations), data storage media decisions (e.g., single level cell vs multi-level cell data storage), and I/O scheduling. Implementations described herein simplify a flash translation layer (FTL) design of the SSD by having the host device manage the SSD's LBA-PBA address conversion, thereby improving the data access speed and reducing latency associated with accessing data.

Implementations described herein may be used for computation-intensive applications, such as computational storage and data processing for AI applications. Implementations described herein include a host ecosystem that defines a data processor unit together with the SSD. Having the entire data storage ecosystem (including both the host device and SSD storage) under a unified data management schema with coherent metadata provides for improved performance and quality of the data storage ecosystem as a whole.

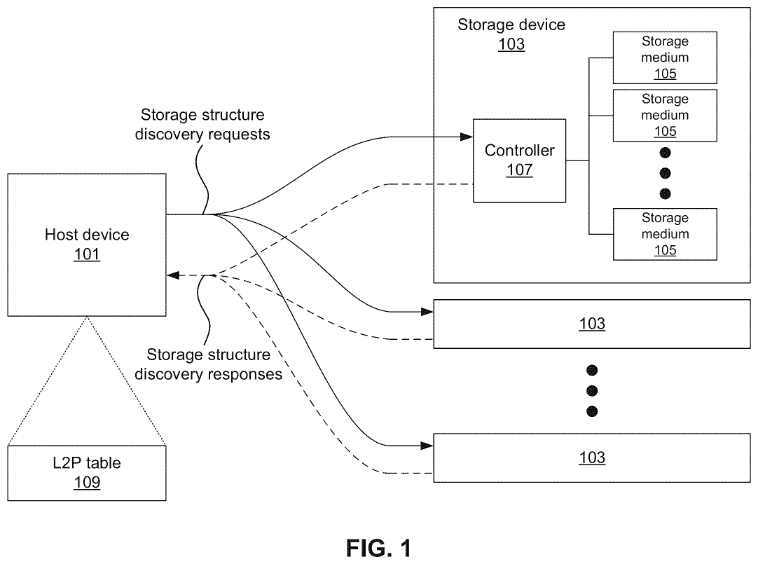

As an example, as shown in FIG. 1, host device 101 may become aware of physical addressing of one or more storage devices 103 (e.g., which may be or may include one or more SSDs). Host device 101 may include one or more devices capable of receiving, generating, storing, processing, and/or providing information associated with generating and maintaining an L2P data structure (or L2P table), as described herein. Host device 101 may include a communication device and a computing device. For example, the host device 101 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

Each storage device 103 may include one or more storage mediums 105 (individually “storage medium 105” and collectively “storage mediums 105”). Storage medium 105 may include a non-volatile memory device. For example, the storage medium 105 may include a Not AND (NAND) memory device. Storage mediums 105 of a particular storage device 103 may be organized by data pools, where a “data pool” may refer to a component of storage device 103 that stores a given type of data. For example, a single level cell (SLC) data pool may refer to a collection of blocks dedicated for storing SLC data type (e.g., data type of data stored in SLC cells). The collection of blocks of the SLC data pool may include SLC cells and may store data in the SLC cells. Similarly, a triple level cell (TLC) data pool may refer to a collection of blocks dedicated for storing TLC data type (e.g., data type of data stored in TLC cells). For instance, the collection of blocks of the TLC data pool may include TLC cells and may store data in the TLC cells. A quadruple (QLC) data pool may include QLC cells and may store data in the QLC cells.

As further shown in FIG. 1, storage device 103 may include controller 107 (e.g., each storage device 103 may include one or more respective controllers 107). Controller 107 may include one or more of an application specific integrated circuit (ASIC) or firmware. Controller 107 may cause operations to be performed on storage device 103, such as read operations (e.g., based on read requests from host device 101 which specify a physical address of one or more storage mediums 105), write operations (e.g., based on write requests from host device 101 which specify a physical address of one or more storage mediums 105), erase operations, garbage collection operations, and health monitoring operations, among other examples. Controller 107 may include or may be communicatively coupled to one or more other components, such as a memory or an error correction code (ECC) component, without limitation. The memory associated with controller 107 may include a RAM, which may be a dynamic random access memory (DRAM) or an SDRAM, among other examples.

In accordance with some implementations, as shown, host device 101 may be communicatively coupled to storage device 103, such as via a high speed interface (e.g., a Peripheral Component Interconnect Express (PCIe) interface or a Compute Express Link (CXL) interface, without limitation). Host device 101 and controller 107 may also be configured to communicate with each other via instructions, commands, or the like. For example, host device 101 may issue storage structure discovery requests to one or more controllers 107 of one or more storage devices 103. In accordance with implementations described herein, the storage structure discovery requests may be requests for information regarding a storage structure. The storage structure may refer to an arrangement of physical memory addresses of storage device 103, such as a quantity of storage mediums 105, identifiers of storage mediums 105, physical addresses associated with each storage medium 105, or other suitable information which may be used to identify or access physical addressable memory locations of storage mediums 105 of storage device 103. In some examples, when storage device 103 is manufactured, storage mediums 105 are configured to provide information indicating a respective capacity. An identification command may be used to read an identification (ID) information of a storage medium 105. The ID information may provide information about a manufacturer of the storage medium 105, a number of dies per chip enable, a number of blocks per plane, and/or a number of planes per die, among other examples of information regarding a storage structure of the storage medium 105. A chip enable may refer to a function that may terminate all or a portion of an operation of an integrated circuit.

Host device 101 may issue such requests as part of an initial configuration or handshake between host device 101 and storage device 103. For example, host device 101 may issue a storage structure discovery request to controller 107 of a particular storage device 103 when such particular storage device 103 is connected to host device 101. In some implementations, host device 101 may output storage structure discovery requests to controller 107 of a given storage device 103 on some other basis, such as a periodic basis, an intermittent basis, or an event-driven basis, without limitation.

Controller 107 may respond to such requests by providing the requested storage structure information to host device 101. Host device 101 may accordingly generate and/or store information that associates each physical address, of one or more storage mediums 105 of one or more storage devices 103, with a logical address in a corresponding entry in L2P table 109.

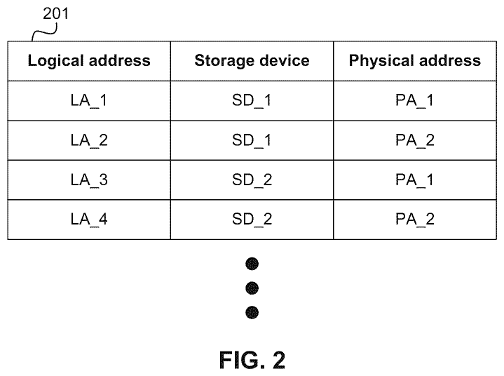

FIG. 2 illustrates an example data structure 201, which may represent L2P table 109 or portions thereof. Data structure 201 (e.g., L2P table 109) may include a set of logical addresses, which may be used by applications, an operating system, or other elements of host device 101 to request I/O operations such as data reads or writes. Data structure 201 may also include physical addressing information, such as an identifier of a particular storage device 103 and/or a physical address thereof, to which a given logical address corresponds. For example, the example logical address “LA_1” may correspond to a physical address “PA_1” on a given storage device 103 represented by “SD_1.” The physical address of LA_1 may also be denoted as “SD_1/PA_1” in this example. In this example, the logical address “LA_2” may correspond to another physical address “PA_2” on the same storage device 103 represented by “SD_1” (e.g., the physical address of LA_2 may also be denoted as “SD_1/PA_2”). Continuing with the example, the logical address “LA_3” may correspond to a physical address “PA_1” on a different storage device 103 represented by “SD_2” (e.g., the physical address of LA_3 may also be denoted as “SD_2/PA_1”), and the logical address “LA_4” may correspond to a physical address “PA_2” on this same storage device 103 represented by “SD_2” (e.g., the physical address of LA_4 may also be denoted as “SD_2/PA_2”).

Host device 101 may usually use logical addresses to access storage device 103. Typically, storage device 103 defines physical locations in storage medium 105 for storing user data. Implementations are described herein with respect to host device 101 using the ID information to define physical locations in storage medium 105 for storing user data. In other words, host device 101 may define the physical locations by gaining insights regarding the storage structure of storage device 103.

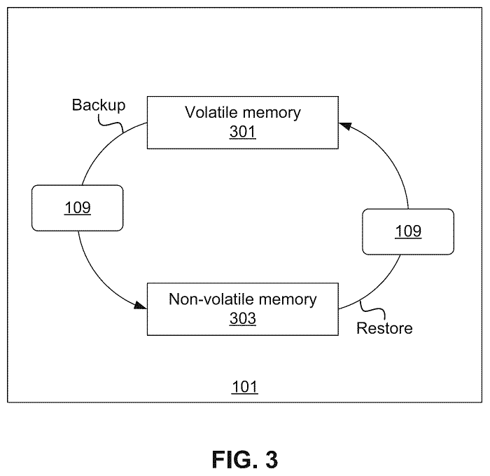

As shown in FIG. 3, host device 101 may maintain L2P table 109 in volatile memory device 301 and/or non-volatile memory device 303. Volatile memory device 301 may include, for example, a RAM such as an SDRAM, a DRAM, or a DDR RAM, without limitation. Non-volatile memory device 303 may include a storage device such as an SSD, a hard disk, or an external storage device, without limitation. Host device 101 may utilize, for example, volatile memory device 301 as an operational and/or run-time storage and access location for L2P table 109 (e.g., may access L2P table 109 from volatile memory device 301 when using L2P table 109 to perform I/O operations) and may utilize non-volatile memory device 303 as a backup for L2P table 109. For example, host device 101 may periodically, intermittently, and/or on some other ongoing basis write a copy of L2P table 109, as maintained by volatile memory device 301, to non-volatile memory device 303. In the event of a power cycle, the copy of L2P table 109 in non-volatile memory 303 may be used to restore L2P table 109 in volatile memory device 301.

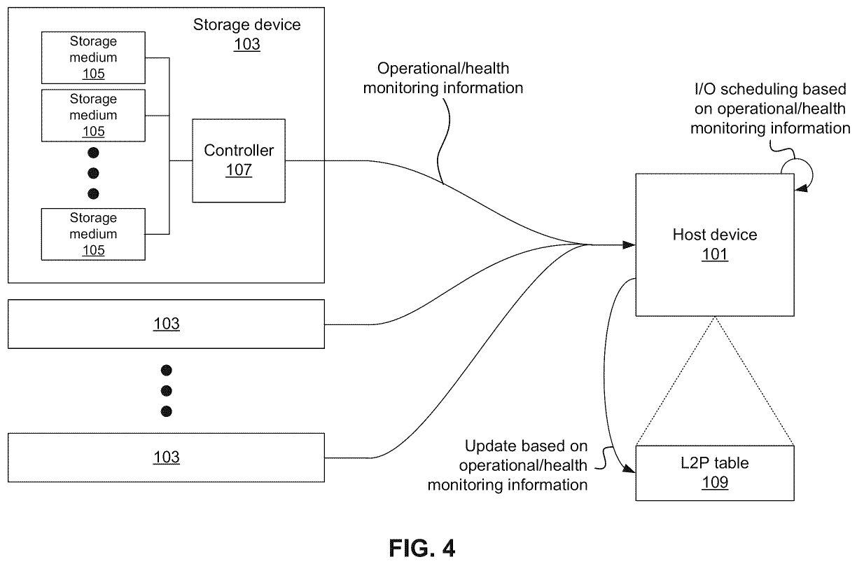

In some implementations, L2P table 109 (e.g., data structure 201) may also include or be associated with other information (e.g., in addition to L2P mapping information). For example, as shown in FIG. 4, controllers 107 of respective storage devices 103 may provide operational and/or health monitoring information to host device 101. Controllers 107 may output such information on a periodic basis, an intermittent basis, an event-driven basis, and/or on some other ongoing basis. Additionally, or alternatively, host device 101 may request the operational and/or health monitoring information, such as on a periodic basis, an intermittent basis, an event-driven basis, and/or on some other ongoing basis.

The health and/or monitoring information may include, without limitation, information regarding program/erase (P/E) cycles, block health, temperature, wear leveling, and/or telemetry data associated with each storage device and/or physical address. The health and/or monitoring information may include data storage information (e.g., whether a given physical address stores user data or is otherwise available for data writes). In other examples, the health and/or monitoring information may include other suitable information associated with the status or health of storage mediums 105 and/or portions thereof of one or more storage devices 103. Host device 101 may accordingly update L2P table 109 to reflect up-to-date operational and/or health monitoring information received from controllers 107 of one or more storage devices 103.

In some implementations, storage device 103 (e.g., controller 107) may keep a local copy of L2P table 109 (or portions thereof) for SSD-level operational management actions, such as garbage collection. A high-speed interface may be used to make L2P table 109, as maintained by host device 101, coherent (e.g., synchronized) between host device 101 and storage device 103. In some implementations, entries of L2P table 109 and entries of the copy of L2P table 109 may be associated with timestamps. In situations, controller 107 may move data from a current physical address to a new physical address and may update the copy of L2P table 109 with the new physical address. An entry associated with the new physical address may be associated with a timestamp indicating when the entry was updated. In this regard, host device 101 may compare a timestamp of a corresponding entry in L2P table 109 and a timestamp of the updated entry in the copy of the L2P table 109 to determine the data has been moved to a different physical location. The timestamp is the moment the address is updated. This timestamp is following (or corresponds to) the same time and dates between host and storage device 103. If an address on storage device 103 is changed by storage device 103, storage device 103 will raise a flag indicating that the address is a newer address for the same data. In some examples, storage device 103 may raise (or set) the flag using bits that may help host device 101 determine a status of storage device 103. The status may indicate whether the same data has been moved to a newer address. In some situations, the bits may include status registers bits (e.g., status first in first out (FIFO) bits). Host device 101 may check the status of storage device 103 using the bits. Host device 101 may check the status periodically and on-demand. Then, based on reading the flag, host device 101 can determine that the address of the data has been updated by storage device 103 and, in response to the determination, update its record in L2P table 109 as well.

The health and/or monitoring information may be used by host device 101 in selecting physical blocks for data writes, scheduling I/O operations, or other suitable operations. For example, the health and/or monitoring information may indicate that controller 107 is performing particular SSD management operations, such as garbage collection or trimming. Host device 101 may take such information into account when scheduling I/O operations, such as writes or reads to or from storage device 103. For example, in this sense, it may be “expected” or “known” to host device 101 that I/O operations may undergo some measurable delay or latency as a result of controller 107 being in the process of performing SSD operations, and the scheduling of I/O operations may be performed accordingly. For example, I/O operations with a higher priority may be scheduled ahead of I/O operations with a lower priority, even if the lower priority I/O operations were initiated prior to initiation of the I/O operations with the higher priority. In this manner, host device 101 is able to exercise a greater level of control and maintain a higher level of “awareness” of the operational state of storage device 103.

As another example, the health and/or monitoring information may be used by host device 101 to determine the relative health or operational status of different physical addresses of storage device 103. In some examples, the health and/or monitoring information may include a bit error rate of a die of storage device 103 (e.g., an intrinsic BER elevation). For instance, as storage device 103 ages or deteriorates, the BER of the die will increase. If host device 101 determines that the increase, of the BER, satisfies a threshold (e.g., the increase exceeds the threshold), then host device 101 may determine that the die is unhealthy. In some instances, host device 101 may avoid writing data to physical addresses that are associated with a measure of health or operational status that is below a threshold, and/or may otherwise utilize per-physical address health or operational status information when selecting physical addresses to which data should be written.

Additionally, in some instances, the health and/or monitoring information may indicate the relocation of data from one physical address to another physical address. For example, in the course of performing SSD management operations, controller 107 of a given storage device 103 may identify a bad block in a given storage medium 105, and may copy data from the bad block to a different block (e.g., having a different physical address) in the same storage medium 105 or a different storage medium 105 of storage device 103. The operational and/or health monitoring information, provided to host device 101 by controller 107, may indicate the moving of data from one physical address to another. Host device 101 may update its copy of L2P table 109 to reflect the moving of data from one physical address to another. For example, host device 101 may identify a particular logical address associated with the physical address from which the data was moved, and may update the L2P information to instead associate the particular logical address with the physical address to which the data was moved.

The health and/or monitoring information may further include, for example, an indication of the removal of a given physical address from a pool of available physical addresses, or the addition of a given physical address to a pool of available physical addresses. Host device 101 may maintain L2P table 109 such that L2P table 109 is up-to-date with currently available and/or unavailable physical addresses of storage mediums 105 of storage devices 103.

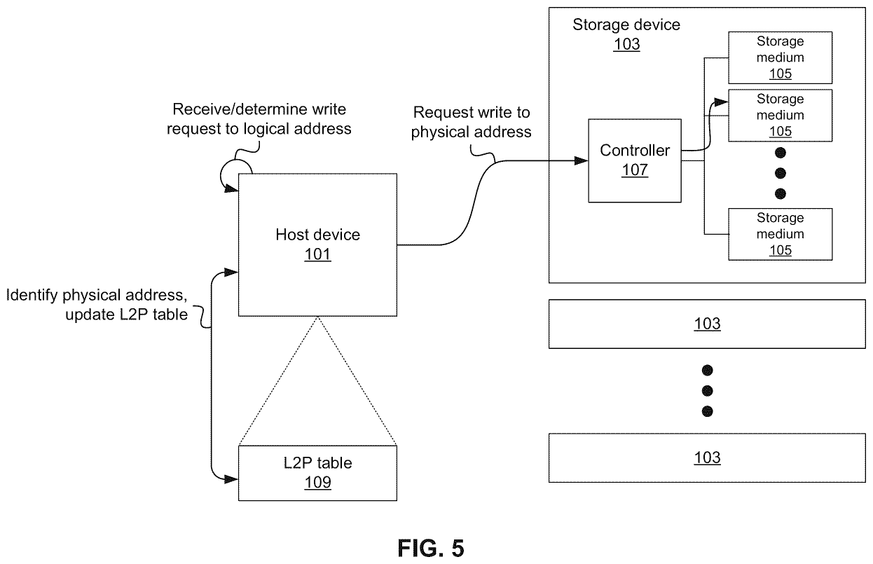

FIG. 5 illustrates an example write operation in accordance with some implementations. As shown, host device 101 may receive or determine a write request to store data at a logical address. For example, an application executing at host device 101, an operating system of host device 101, and/or some other component of host device 101 may provide or initiate the write request. Host device 101 may, for example, make some or all of the logical addresses included in L2P table 109 available to other elements of host device 101 (e.g., applications and/or the operating system, without limitation), such that the logical addresses are able to be invoked by the other elements of host device 101. Host device 101 may identify, using L2P table 109, a physical address that corresponds to the logical address. For example, host device 101 may identify one or more particular storage devices 103, one or more particular storage mediums 105, and/or one or more particular physical addresses within one or more storage mediums 105 that correspond to the logical address. In some examples, host device 101 may determine a storage capacity of storage device 103 using the ID information. Accordingly, host device 101 may know how much address space is needed for a given number of 512B data. This address space may be referred to as an LBA address space. Physically, the data is to be stored in one or more physical locations of storage device 103 (which may be different than LBA). The one or more physical locations may be referred to as the PBA. Host device 101 may determine the PBA based on the storage capacity of storage device 103.

Host device 101 may accordingly output a write request to controller 107 of the identified storage devices 103. Controller 107 may accordingly write the requested data to the indicated physical address, such as to a particular storage medium 105 of storage device 103. While this example shows host device 101 outputting the request to a single controller 107 of a single storage device 103, similar concepts may apply in situations in which a write request specifies one or more logical addresses that span multiple storage devices 103 and/or storage mediums 105. In such situations, host device 101 may output corresponding write requests to multiple controllers 107 of multiple storage devices 103, either sequentially or in parallel, in accordance with some implementations.

Host device 101 may additionally update L2P table 109 to reflect the data written to the physical address(es) of the one or more storage devices 103. For example, host device 101 may update an entry in L2P table 109, corresponding to the logical address, to associate the logical address with a particular storage device 103, storage medium 105, and/or physical address within storage medium 105 to which the data was written. In some implementations, host device 101 may update the entry during a write operation initiated by host device 101 or a write operation initiated by storage device 103. In some examples, storage device 103 may initiate the write operation as part of a garbage collection operation.

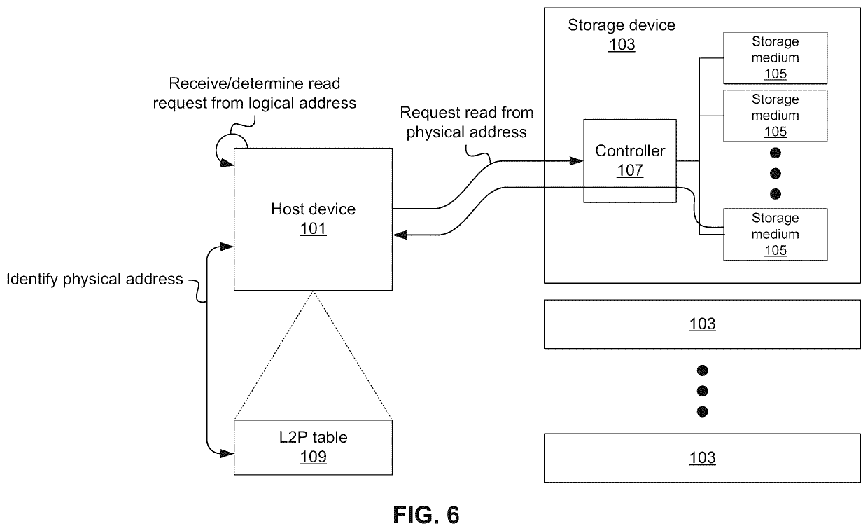

FIG. 6 illustrates an example read operation in accordance with some implementations. As shown, host device 101 may receive or determine a read request to read data stored at a particular logical address. For example, an application executing at host device 101, an operating system of host device 101, and/or some other component of host device 101 may provide or initiate the read request. Host device 101 may identify, using L2P table 109, a physical address that corresponds to the logical address. For example, host device 101 may identify one or more particular storage devices 103, one or more particular storage mediums 105, and/or one or more particular physical addresses within one or more storage mediums 105 that correspond to the logical address.

Host device 101 may accordingly output a read request to controller 107 of the identified storage devices 103 (e.g., a particular storage device 103, in this example). Controller 107 may accordingly read the requested data from the indicated physical address, and may output the requested data to host device 101. Host device 101 may provide the requested data, such as to an application, operating system, and/or other element of host device 101 from which the read request was received.

Implementations described herein provide multiple technical benefits. For example, implementations described herein may be useful for host device 101 to truly manage data I/O operations. In some situations, management of the data I/O operations may be especially useful for new non-volatile memory express (NVMe) features such zone name space (ZNS), and flash data placement (FDP). Implementations described herein may also be useful for SSD live migration by moving (copying or transferring) the same data structure and settings from one SSD to another SSD. For example, L2P table 109 that is based on a given storage device 103 may be copied, duplicated, or otherwise used for another storage device 103, thus providing a measure of scalability for hyperscale SSDs by alleviating the addressing burden to more power host device processors such as CPUs or GPUs. Implementations described herein may provide more secure SSD access with the addressing scheme outside the data storage device. For example, a boot drive may hold the addressing tables.

As indicated above, FIGS. 1-6 are provided as examples. Other examples may differ from what is described with regard to FIGS. 1-6. The number and arrangement of devices shown in FIGS. 1-6 are provided as an example. In practice, there may be additional devices, fewer devices, different devices, or differently arranged devices than those shown in FIGS. 1-6. Furthermore, two or more devices shown in FIGS. 1-6 may be implemented within a single device, or a single device shown in FIGS. 1-6 may be implemented as multiple, distributed devices. Additionally, or alternatively, a set of devices (e.g., one or more devices) shown in FIGS. 1-6 may perform one or more functions described as being performed by another set of devices shown in FIGS. 1-6.

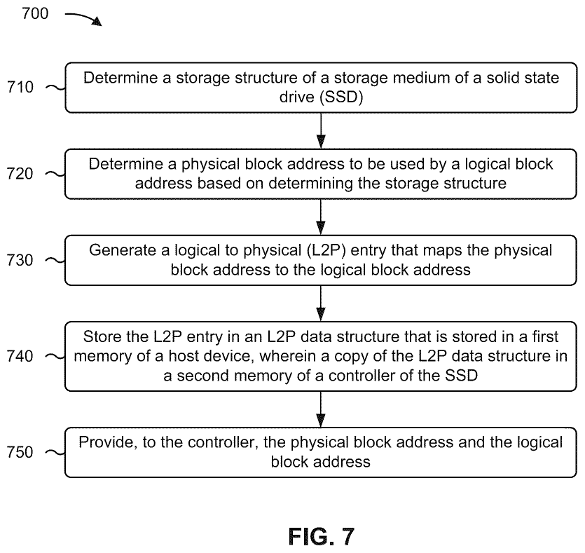

FIG. 7 is a flowchart of an example process 700 associated with generating an L2P data structure stored by a host device. In some implementations, one or more process blocks of FIG. 7 may be performed by a host device (e.g., host device 101). In some implementations, one or more process blocks of FIG. 7 may be performed by another device or a group of devices separate from or including the host device, such as a controller (e.g., controller 107). As an example, example process 700 may be performed when a write operation is initiated by the host device. Alternatively, example process 700 may be performed when a write operation is initiated by storage device 103 (e.g., the controller).

As shown in FIG. 7, process 700 may include determining a storage structure of a storage medium of an SSD (block 710). For example, host device 101 may determine a storage structure of a storage medium of an SSD, such as storage device 103, as described above. For example, host device 101 may provide requests and controller 107 may respond to such requests by providing storage structure information to host device 101 regarding a storage structure of storage device 103, as described in connection with FIG. 1. Using the storage structure information, host device 101 may determine an arrangement of physical memory addresses of storage device 103, such as a quantity of storage mediums 105, identifiers of storage mediums 105, physical addresses associated with storage mediums 105, or other suitable information which may be used to identify or access physical addressable memory locations of storage mediums 105 of storage device 103. Accordingly, using the storage structure information, host device 101 may determine an overall storage capacity of storage device 103, an available storage capacity of storage device 103, a manufacturer of storage device 103 and of storage mediums 105, a configuration of storage mediums 105, an available storage capacity of storage mediums 105, a number of channels of storage device 103, a number of chip-enables per channel, and a number of dies per chip-enable, without limitation. The configuration of storage mediums 105 may include a number of planes, a number of blocks per plane, a storage capacity per block, without limitation.

As further shown in FIG. 7, process 700 may include determining a physical block address to be used by a logical block address based on determining the storage structure (block 720). For example, host device 101 may determine a physical block address to be used by a logical block address based on determining the storage structure, as described above. For example, host device 101 may use the storage structure information to determine the physical block address to be used by the logical block address. For instance, based on determining the storage structure as explained herein, host device 101 may determine one or more physical addresses, of one or more storage mediums 105 of one or more storage devices 103, to store data (e.g., user data). For example, based on a size of the data, host device 101 may identify one or more memory locations (of one or more storage mediums 105) available to store the data and may determine one or more physical addresses of the one or more memory locations. After determining the one or more physical addresses, host device 101 may determine one or more logical addresses corresponding to the one or more physical addresses.

As further shown in FIG. 7, process 700 may include generating an L2P entry that maps the physical block address to the logical block address (block 730). For example, host device 101 may generate an L2P entry that maps the physical block address to the logical block address.

As further shown in FIG. 7, process 700 may include storing the L2P entry in an L2P data structure that is stored in a first memory of a host device, such as L2P table 109. A copy of the L2P data structure, or a portion thereof, may be maintained in a second memory of a controller of storage device 103 (block 740). For example, the host device may store the L2P entry in an L2P data structure that is stored in a first memory of a host device, wherein a copy of the L2P data structure or portion thereof is also stored in a second memory of a controller of storage device 103, as described above.

As further shown in FIG. 7, process 700 may include providing, to the controller, the physical block address and the logical block address (block 750). For example, the host device may provide, to the controller, the physical block address and the logical block address, as described above. For instance, controller 107 may keep a local copy of L2P table 109, as described above in connection with FIG. 3. In this regard, host device 101 may provide the local copy of L2P table 109 to controller 107. The local copy of L2P table 109 may include entries identifying physical addresses and logical addresses corresponding to the physical addresses. In some situations, controller 107 may buffer one or more entries, of the local copy of L2P table 109, in a local memory of controller 107. Buffering the one or more entries may enable controller 107 to quickly access the one or more entries and quickly perform operations associated with physical addresses identified by the one or more entries. In some implementations, the physical block address and the logical block address are provided to perform a write operation or a read operation at a physical location, of the storage medium (e.g., a storage medium 105), identified by the physical block address.

In some implementations, the first memory includes a first SDRAM, and the second memory includes a second SDRAM.

In some implementations, determining the storage structure comprises determining a physical block arrangement of blocks of the storage medium. For example, the storage structure information may indicate an arrangement of physical memory addresses of storage device 103, as described in connection with FIG. 1.

In some implementations, the copy of the L2P data structure is updated by setting a timestamp and a flag for at least one L2P entry associated with the operation. For example, entries of L2P table 109 and entries of the copy of L2P table 109 may be associated with timestamps indicating when the entries were updated, as described in connection with FIGS. 3 and 4. If an address on storage device 103 is changed by storage device 103, storage device 103 will raise a flag indicating that the address is a newer address for the same data, as described in connection with FIGS. 3 and 4. Process may include synchronizing L2P entries of the L2P data structure and L2P entries of the copy of the L2P data structure after the copy of the L2P data structure has been updated, as described in connection with FIGS. 3 and 4.

In some implementations, process 700 includes synchronizing L2P entries of the L2P data structure and L2P entries of the copy of the L2P data structure during a power cycle of storage device 103, wherein the L2P entries of the copy of the L2P data structure are stored in a non-volatile memory device of storage device 103 during the power cycle, as described in connection with FIGS. 3 and 4.

In some implementations, process 700 includes synchronizing L2P entries of the L2P data structure and L2P entries of the copy of the L2P data structure using a coherency protocol.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

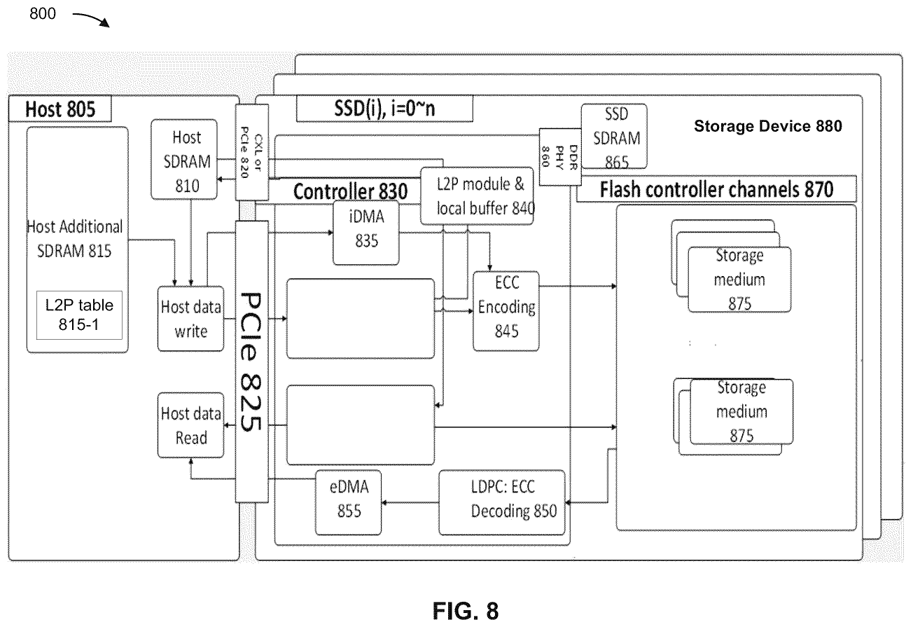

FIG. 8 is a diagram of an example system 800 described herein. Example system 800 describes components and operations associated with a host 805 (also referred to as “host device 805”) and a storage device 880. In some implementations, storage device 880 may include a solid state drive (SSD). As shown in FIG. 8, storage device 880 may be associated with a host device 805. Host device 805 may write data (also referred to as “host data”) to storage device 880. For example, as shown in FIG. 8, host device 805 may initiate a host data write operation (e.g., a write operation) to write the host data to storage device 880 (e.g., to store the data on storage device 880) and may initiate a host read operation (e.g., a read operation) to read the host data from storage device 880.

Host device 805 may include one or more devices capable of receiving, generating, storing, processing, and/or providing information associated with generating an L2P data structure (or L2P table), as described elsewhere herein. The host device 805 may include a communication device and a computing device. For example, the host device 805 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

As shown in FIG. 8, host device 805 may include a host synchronous dynamic random access memory (SDRAM) 810 and a host additional SDRAM 815. Host SDRAM 810 may store a large amount of data compared to an amount of data stored by host additional SDRAM 815. For example, host additional SDRAM 815 may store tens of terabytes. Host SDRAM 810 may store L2P data structures. In some examples, host SDRAM 810 may store information that may be used by host device 805 to manage physical block addresses (or physical addresses) of multiple SSDs and conduct leveling between SSDs.

L2P table 815-1 may store a mapping between host logical block addresses (e.g., logical addresses identified by host device 805) and physical block addresses (e.g., physical addresses of non-volatile memory devices of storage device 880). In some implementations, L2P table 815-1 may be generated by host device 805.

In some implementations, host device 805 may identify a host logical block address (HLBA) associated with the host data by which host device 805 may reference the host data in a future read operation. Host device 805 may convert the HLBA to a flash logical block address (FLBA) or other logical block address of storage device 880, and then may link the FLBA to a physical block address (PBA) using an L2P conversion process,

In some examples, host 805 and storage device 880 may exchange data via a Compute Express Link (CXL) or a Peripheral Comp Interconnect Express (PCIe) 820. In some examples, host 805 and storage device 880 may exchange data via PCIe 825.

As shown in FIG. 8, storage device 880 may include a controller 830. Controller 830 may include one or more of an application specific integrated circuit (ASIC) or firmware. Controller 830 may cause functions to be performed on storage device 880, such as read operations, write operations, erase operations, and garbage collection operations, among other examples. Controller 830 may include an ingress direct memory access (iDMA) 835, L2P module and local buffer 840, an error correction code (ECC) encoding 845, an ECC decoding 850, and an egress direct memory access (eDMA) 855 (e.g., an eDMA engine).

Controller 830 may store a copy of the links between the HLBA, the FLBA, and the PBA in L2P module and local buffer 840. In some aspects, the host data may be moved within the storage medium or between storage mediums of storage device 880, which controller 830 may note in the link between the FLBA and the physical location. In this way, the HLBA may bypass being updated when the host data is moved to a new PBA.

In some examples, iDMA 835 may be used, by controller 830, to process the host data in preparation for storage of the host data on storage device 880. L2P module and local buffer 840 may be used to store a copy of an L2P table generated by host 805. ECC encoding 845 may include an ECC engine. ECC encoding 845 may perform error correction code encoding on the host data. In some implementations, the error correction code encoding may include adding redundancy, parity bits, or other information that can later be used to identify errors in the host data when read from the storage medium. Controller 830 may provide the host data, after encoding, via flash controller channels 870 to write on storage mediums of storage device 880. ECC decoding 850 may perform error correction code decoding on host data requested by host 805. In some examples, controller 880 may perform an eDMA operation (e.g., using eDMA 855) to isolate the host data request by host 805 via a read request. For example, an eDMA controller (e.g., eDMA engine) may perform eDMA to isolate data to be delivered to host 805 in association with a read request from host 805. In some aspects, host 805 may send multiple read requests to storage device 880 and eDMA 855 may be used to isolate a portion of the host data that is to be provided to host 805 for a specific read request.

Once a PBA is identified in connection with a host data read request, controller 830 may read an appropriate storage medium 875 at the PBA via flash controller channels 870. Controller 830 may perform decoding on data read from the storage medium 875 using ECC decoding 850. Controller 830 may perform eDMA, using eDMA 855, to isolate the host data of the request for sending to host 805. For example, the eDMA engine may perform eDMA to isolate data to be delivered to host 805.

As shown in FIG. 8, storage device 880 may include storage mediums 875 (individually “storage medium 875” and collectively “storage mediums 875”). A storage medium 875 may include a non-volatile memory device. For example, the storage medium 875 may include a NAND memory device. As shown in FIG. 8, storage device 880 may include double data rate (DDR) device 860 and an SSD SDRAM 865. In some examples, DDR device 860 may store data that may be used by controller 830 to control operations performed on storage device 880, such as read operations and/or write operations. SSD SDRAM 865 may operate as an internal data buffer for storage device 880. In some examples, SSD SDRAM 865 may store tens of gigabytes of data.

As indicated above, FIG. 8 is provided as an example. Other examples may differ from what is described with regard to FIG. 8. The number and arrangement of devices shown in FIG. 8 are provided as an example. In practice, there may be additional devices, fewer devices, different devices, or differently arranged devices than those shown in FIG. 8. Furthermore, two or more devices shown in FIG. 8 may be implemented within a single device, or a single device shown in FIG. 8 may be implemented as multiple, distributed devices. Additionally, or alternatively, a set of devices (e.g., one or more devices) shown in FIG. 8 may perform one or more functions described as being performed by another set of devices shown in FIG. 8. DF

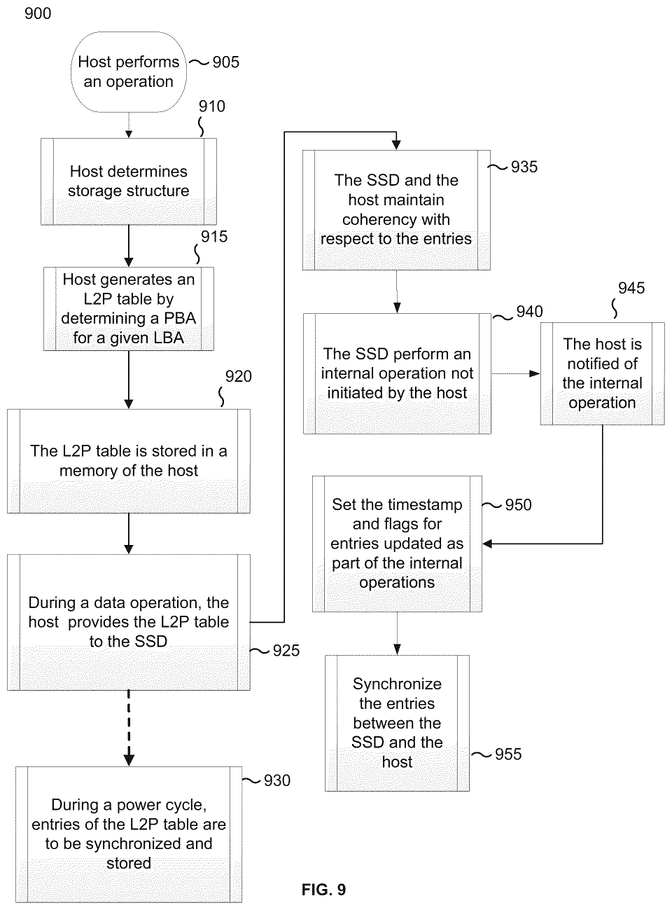

FIG. 9 is a flowchart of an example process 900 associated with generating a logical to physical data structure stored by a host device. In some implementations, one or more process blocks of FIG. 9 may be performed by a host device (e.g., host device 101). In some implementations, one or more process blocks of FIG. 9 may be performed by another device or a group of devices separate from or including the host device, such as a controller of an SSD (e.g., controller 130 of storage device 103). As an example, process 900 may be performed when a write operation is initiated by the host device. Alternatively, example process 900 may be performed when a write operation is initiated by storage device 103 (e.g., the controller).

As shown in FIG. 9, process 900 may include the host device performing an operation (block 905). In some examples, host device 101 may perform a write operation on storage device 103.

As shown in FIG. 9, process 900 may include the host device determining the storage structure of the SSD (block 910). For example, host device 101 may provide storage structure discovery requests to controller 107, as described above in connection with FIG. 1. In some situations, host device 101 may determine a physical block arrangement and a NAND organization, of storage device 103, by performing media ID reads. A “media ID read” may be used to refer to a status read operation to obtain information regarding the storage structure of different storage mediums 105.

As shown in FIG. 9, process 900 may include the host device generating an L2P table by determining a PBA for a given LBA (block 915). For example, based on determining the storage structure, host device may generate and/or store information that associates each physical address, of one or more storage mediums 105 of one or more storage devices 103, with a logical address in a corresponding entry in the L2P table, as described in FIG. 1.

As shown in FIG. 9, process 900 may include the L2P table being stored in a memory of the host device (block 920). For example, host device 101 may store the L2P table may store the L2P table n a volatile memory device 301 and/or non-volatile memory device 303, as explained above in connection with FIG. 3.

As shown in FIG. 9, process 900 may include, during the data operation, the host device sending the L2P table to the SSD (block 925). For example, host device 101 may initiate a write operation on storage device 103. As part of the write operation, host device 101 may provide a copy of the L2P to storage device 103 for storage. In some examples, the copy of the L2P table may be stored in a memory associated with controller 107. The memory associated with controller 107 may include a RAM, such as a DRAM or a SDRAM.

As shown in FIG. 9, process 900 may include, during a power cycle, entries of the L2P table may be synchronized and stored (block 930). For example, during a power cycle experienced by storage device 103, the entries of the copy of the L2P table (previously stored in the memory associated with controller 107) may be synchronized with the entries of the L2P table stored in the memory of the host device. As an example, controller 107 may provide (to host device 101) request to obtain a copy of the entries of the L2P table stored in the memory of the host device. The copy of the entries (obtained from host device 101) may be stored in a non-volatile memory of storage device 103. The “power cycle” may refer to an event during which power, supplied to storage device 103, is interrupted. In this regard, the entries of the copy of the L2P table may be stored in the non-volatile memory as part of a back up operation for the entries. As an example, the entries of the copy of the L2P table may be stored on a boot drive of storage device 103.

As shown in FIG. 9, process 900 may include the SSD and the host device maintaining coherency with respect to the entries (such as a boot drive) (block 935). For example, controller 107 (of storage device 103) and host device 101 may maintain coherency with respect to the entries of the L2P table of host device 101 and the entries of the copy of the L2P table of storage device 103. As explained in connection with FIGS. 3 and 4, controller 107 (of storage device 103) and host device 101 may maintain the coherency using flags associated with the entries. Maintaining the coherency using flags may be referred to as “snooping.”

As shown in FIG. 9, process 900 may include the SSD performing an internal operation that is not initiated by the host device (block 940). For example, controller 107 ma initiate an internal operation on one or more storage mediums 105. The internal operation may include a garbage collection operation, a read scrub operation, among other examples.

As shown in FIG. 9, process 900 may include the host device being notified of the storage device 103 internal operations (block 945). In some situations, as a part of the internal operation, host data (provided by host device 101) may be moved from a first physical location (e.g., a first PBA) to a second physical location (e.g., a second PBA). Accordingly, controller 107 may update the entries of the copy of the L2P table to reflect the change from the first PBA to the second PBA. Additionally, controller 107 may notify host device 101 that the internal operation has been performed and may notify host device 101 of the change from the first PBA to the second PBA.

As shown in FIG. 9, process 900 may include setting the timestamp and flags for entries updated as part of the internal operation (block 950). For example, an entry associated with the first PBA may be associated with a timestamp indicating when the entry was updated, as described above in connection with FIG. 4. Additionally, or alternatively, controller 107 will generate a flag indicating that the second PBA is a newer address for the same data, as described above in connection with FIG. 4.

As shown in FIG. 9, process 900 may include synchronizing the entries between the SSD and the host device (block 955). In some examples, host device 101 may compare a first timestamp of an entry of the L2P table and a second timestamp of a corresponding entry of the copy of the L2P table to identify the data that has been moved to a different physical location. Host device 101 may update the entry of the L2P table based on the first timestamp being older than the second timestamp. As mentioned above, the coherency between entries may be maintained using snooping.

Although FIG. 9 shows example blocks of process 900, in some implementations, process 900 may include additional blocks, fewer blocks, different blocks, or differently arranged blocks than those depicted in FIG. 9. Additionally, or alternatively, two or more of the blocks of process 900 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
determining a storage structure of a storage medium of a solid state drive (SSD);
determining a physical block address to be used by a logical block address based on determining the storage structure;
generating a logical 2 physical (L2P) entry that maps the physical block address to the logical block address;
storing the L2P entry in an L2P data structure that is stored in a first memory of a host device,
wherein a copy of the L2P data structure is stored in a second memory of a controller of the SSD; and
providing, to the controller, the physical block address and the logical block address,
wherein the physical block address and the logical block address are provided to perform a write operation or a read operation at a physical location, of the storage medium, identified by the physical block address.

2. The method of claim 1, wherein the first memory includes a first read-only memory or random-access memory, and
wherein the second memory includes a second read-only memory or random-access memory.

3. The method of claim 2, wherein determining the storage structure comprises:
determining a physical block arrangement of blocks of the storage medium.

4. The method of claim 1, comprising:
receiving a notification that an operation has been initiated on the SSD,
wherein the operation includes a garbage collection operation or a read scrub operation, and
wherein the copy of the L2P data structure is updated based on the operation initiated by the SSD.

5. The method of claim 4, wherein the copy of the L2P data structure is updated by setting a timestamp and a flag for at least one L2P entry associated with the operation,
wherein the method comprises:
synchronizing L2P entries of the L2P data structure and L2P entries of the copy of the L2P data structure after the copy of the L2P data structure has been updated.

6. The method of claim 1, comprising:
synchronizing L2P entries of the L2P data structure and L2P entries of the copy of the L2P data structure during a power cycle of the SSD,
wherein the L2P entries of the copy of the L2P data structure are stored in a non-volatile memory device of the SSD during the power cycle.

7. The method of claim 1, comprising:
synchronizing L2P entries of the L2P data structure and L2P entries of the copy of the L2P data structure using a coherency protocol.

8. A system comprising:
a host device to:
determine a storage structure of a storage medium of a storage device;
determine a physical block address to be used by a logical block address based on determining the storage structure;
generate a logical 2 physical (L2P) entry that maps the physical block address to the logical block address;
store the L2P entry in an L2P data structure that is stored in a memory of a host device; and
provide, to a controller of the storage device, the physical block address and the logical block address,
wherein the physical block address and the logical block address are provided to access a physical location, of the storage medium, identified by the physical block address.

9. The system of claim 8, comprising the controller,
wherein the controller is to store a copy of the L2P data structure in a memory of a controller of the storage device.

10. The system of claim 9, wherein the controller is to:
initiate an operation on the storage device; and
provide, to the host device, a notification that the operation has been initiated on the storage device,
wherein the operation includes a garbage collection operation or a read scrub operation.

11. The system of claim 10, wherein the controller is to:
update the copy of the L2P data structure based on the operation initiated by the storage device.

12. The system of claim 11, wherein the controller is to:
set a timestamp and a flag for at least one L2P entry associated with the operation to update the copy of the L2P data structure; and
synchronize L2P entries of the L2P data structure and L2P entries of the copy of the L2P data structure after the copy of the L2P data structure has been updated.

13. The system of claim 9, wherein the host device is to:
synchronize L2P entries of the L2P data structure and L2P entries of the copy of the L2P data structure during a power cycle of the storage device,
wherein the L2P entries of the copy of the L2P data structure are stored in a non-volatile memory device of the storage device during the power cycle.

14. The system of claim 13, wherein the host device is to:
store the L2P entries of the copy of the L2P data structure in a non-volatile memory device of the storage device during the power cycle.

15. A non-transitory computer-readable medium storing a set of instructions, the set of instructions comprising:
one or more instructions that, when executed by one or more processors of a host device, cause the host device to:
determine a storage structure of a storage medium of a solid state drive (SSD);
determine a physical block address to be used by a logical block address based on determining the storage structure;
generate a logical 2 physical (L2P) entry that maps the physical block address to the logical block address;
store the L2P entry in an L2P data structure that is stored in a first memory of a host device,
wherein a copy of the L2P data structure in a second memory of a controller of the SSD; and
provide, to the controller, the physical block address and the logical block address,
wherein the physical block address and the logical block address are provided to perform a write operation or a read operation at a physical location, of the storage medium, identified by the physical block address.

16. The non-transitory computer-readable medium of claim 15, wherein the one or more instructions, that cause the host device to determine the storage structure, cause the host device to:
determine a physical block arrangement of blocks of the storage medium.

17. The non-transitory computer-readable medium of claim 15, comprising:
one or more instructions to receive a notification that an operation has been initiated on the SSD,
wherein the operation includes a garbage collection operation or a read scrub operation, and
wherein the copy of the L2P data structure is updated based on the operation initiated by the SSD.

18. The non-transitory computer-readable medium of claim 15, wherein the copy of the L2P data structure is updated by setting a timestamp and a flag for at least one L2P entry associated with the operation,
wherein the one or more instructions further cause the host device to:
synchronize L2P entries of the L2P data structure and L2P entries of the copy of the L2P data structure after the copy of the L2P data structure has been updated.

19. The non-transitory computer-readable medium of claim 15, comprising:
one or more instructions to synchronize L2P entries of the L2P data structure and L2P entries of the copy of the L2P data structure during a power cycle of the SSD,
wherein the L2P entries of the copy of the L2P data structure are stored in a non-volatile memory device of the SSD during the power cycle.

20. The non-transitory computer-readable medium of claim 15, comprising:
one or more instructions to synchronize L2P entries of the L2P data structure and L2P entries of the copy of the L2P data structure using a coherency protocol.
